(19) United States
(12) Patent Application Publication
(10) Pub. No.: US 2003/0005019 A1
(43) Pub. Date: Jan. 2, 2003

(54) Application frameworks for mobile devices

(76) Inventors: Kuldipsingh Pabla, Santa Clara, CA (US); Rajesh Kanungo, Sunnyvale, CA (US); Venkatesh Narayanan, Fremont, CA (US)

Correspondence Address: MARTINE & PENILLA, LLP, SUN MICROSYSTEMS, INC., 710 LAKEWAY DRIVE, SUITE 170, SUNNYVALE, CA, 94085, US

(21) Appl. No.: 09/681,930

(22) Filed: Jun. 27, 2001

(51) Int. Cl. G06F 17/00

(52) U.S. Cl. 709/1

(57) ABSTRACT

An application framework for mobile devices is described comprising a three-tier software architecture for wireless devices to allow high-powered backend services to be accessible by low-powered wireless client devices. The present invention defines a layered end-to-end architecture and an application framework, called mobilet framework, for client devices to allow applications to run on wireless devices in a vendor-neutral and platform independent manner. The wireless device may be viewed as a cache or a viewport through which high-end services can be accessed. The cache may be synchronized periodically with the servers and/or service providers through a gateway portal targeted specifically at low-end wireless devices. The mobilet framework for low-end client devices defines an Application Programming Interface as well as an abstraction for platform independent applications called mobilets.

### CROSS REFERENCE TO RELATED APPLICATIONS

This Application is related to U.S. Utility Application No., entitled “Application Framework For Mobile Devices”, filed on Jun. 22, 2001, specification of which is herein incorporated by reference.

### BACKGROUND OF INVENTION

1. Field of the Invention

This invention relates to the field of software architecture for wireless devices. More specifically the invention relates to an application framework for wireless client devices to allow applications to run on these devices in a vendor-neutral and platform independent manner.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever. Sun, Sun Microsystems, the Sun logo, Solaris, Java, JavaOS, JavaStation, HotJava Views, Jini and all Java-based trademarks and logos are trademarks or registered trademarks of Sun Microsystems, Inc., in the United States and other countries. All SPARC trademarks are used under license and are trademarks of SPARC International, Inc., in the United States and other countries. Products bearing SPARC trademarks are based upon an architecture developed by Sun Microsystems, Inc.

2. Background Art

The wireless communication environment is characterized by the existence of multiple commercial networks, such as Mobitex, Cellular Digital Packet Data (CDPD), Global System for Mobile communication (GSM), Radio Frequency (RF), satellite, cellular and/or Wireless Application Protocol (WAP), XHTML (Extended Hyper Text Markup Language), or Wireless LAN (Local Area Network) networks, and numerous other protocols. Incompatibility between these networks makes it impossible to create common applications for devices that use these protocols. Current systems operate in an end-to-end fashion. That is, services are linked from provider to clients of that provider and are usually independent of other providers.

Another problem is that wireless devices like cellular phones, pagers, Personal Data Assistants (PDA) have very small footprints (i.e. they are small). Thus, they have limited memory, processing capacities, and display size, hence, are limited in the size of applications that they can process. Current systems cannot support multiple applications. For example, some cellular phones have four lines of display and some have up to six. The differing capabilities limits the size of applications that are available for these devices. The proposed application framework makes these limitations transparent. The framework allows service providers to field applications or provide applications to these wireless devices without much knowledge about what these devices are actually capable of.

The following definitions are examples of the various forms of wireless communication protocols. They are not intended to be a complete list of the various protocols used in the wireless communication industry.

CDPD (Cellular Digital Packet Data) is a specification for supporting wireless access to the Internet and other public packet-switched networks. CDPD is an open specification that adheres to the layered structure of the Open Systems Interconnection model and has the ability to be extended in the future. CDPD's support for packet-switching means that a persistent link is not needed. The same broadcast channel may be shared among a number of users at the same time.

GSM (Global System for Mobile) is a digital mobile telephone system that is widely used in Europe and other parts of the world. GSM uses a variation of time division multiple access (TDMA) and is the most widely used of the three digital wireless telephone technologies (TDMA, GSM, and CDMA (code-division multiple access)).

Mobitex is a packet switched system for mobile data communication. This means that all data are transferred over radio waves in customized units or packets. This way, the network is used efficiently, and connection times are very short. One advantage of this is that subscribers only pay for packets of data that are sent and not for the connection time with, for example, a mobile telephone. This means that the system connects senders and receivers wherever they are in the area covered (known as roaming). A great advantage of the Mobitex network is that messages that are sent are coded in a special way so that the network automatically corrects mistakes and requests a re-send. So the receiver can be sure that no distorted or incorrect messages are delivered.

### SUMMARY OF INVENTION

An application framework for mobile devices is described. In one embodiment, a three-tier software architecture for wireless devices to allow high-powered backend services to be accessible by low-powered wireless client devices. The present invention defines a layered end-to-end architecture and an application framework for client devices to allow applications to run on these wireless devices in a vendor-neutral and platform independent manner thereby making footprint and protocol restrictions transparent to the client.

In one or more embodiments, a wireless device may be viewed as a cache or a viewport through which high-end services can be accessed. The cache may be synchronized periodically with the servers and/or service providers through a gateway portal targeted specifically at low-end wireless devices. Some of these services may be local, some remote and some split in-between the low-end client and the higher end server. The present mobilet framework for low-end client devices defines an Application Programming Interface (API) as well as an abstraction for platform independent (e.g. Java) applications called mobilets. This framework allows server application and client application interaction on a class of devices in a vendor neutral manner.

### BRIEF DESCRIPTION OF DRAWINGS

FIG. 1 is a diagram of the end-to-end protocol view for the wireless client, in accordance with one embodiment of the present invention.

FIG. 2 is an illustration of the layered structure of the client tier, in accordance with one embodiment of the present invention.

FIG. 3 is a state diagram depicting the life of a mobilet in the framework, in accordance with one embodiment of the present invention.

FIG. 4 is a block diagram of a processing environment comprising an object-oriented runtime environment capable of providing a suitable software execution environment for an embodiment of the present invention.

FIG. 5 is a block diagram of one embodiment of a computer system capable of providing a suitable hardware execution environment for an embodiment of the present invention

### DETAILED DESCRIPTION

The invention defines a three-tier software architecture for wireless devices to allow high-powered backend services to be accessible by low-powered wireless client devices. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

In general, low-powered wireless devices like cell phones, pagers, and Personal Data Assistants (PDA), have small footprints and communicate using various incompatible protocols. Usually, wireless devices use protocols that are service provider dependent therefore making it difficult to run common applications across services (i.e. protocol). In addition, these devices are limited in display size, memory and processing power. For example, some devices have four lines of display and some have up to six. Moreover, the specifications on wireless devices constantly vary as manufacturers vie to reduce footprint while providing more functionality. This makes it difficult to standardize and provide applications across protocols.

Different service providers use different protocols to communicate with clients on their wireless networks, making it virtually impossible to develop applications that are device independent. This invention defines a framework whereby wireless applications can be run independent of protocol, footprint, and display size. That is, applications developed for this framework will be able to run on any wireless device without prior knowledge of the capabilities of the devices. For purposes of this specification, applications that run on this framework are called mobilets because of their applicability to mobile (i.e. wireless) services.

Traditionally, Internet devices like screen phones and set top boxes have been fat clients. That is, they have a high-end rendering engine and a set of services resident in the devices. This functionality requires the devices to have more memory and more processing power than is cost efficient for small devices.

The present invention describes a three-tier software architecture for wireless devices to allow high-powered backend services to be accessible by low powered wireless client devices. For example, services that are generally available on desktop and similar environments can be made available to the mobile user independent of service provider. The present invention defines a layered end-to-end architecture and an application (i.e. mobilet) framework for client devices to allow applications to run on these wireless devices in a vendor-neutral and platform independent manner.

A wireless device can be viewed as a cache or a viewport through which high-end services can be accessed. The cache may be synchronized periodically with the servers and/or service providers through a gateway portal targeted specifically at low-end wireless devices. Some of these services may be local, some remote and some split in-between the low-end client and the higher end server. The present mobilet framework for low-end client devices defines an Application Programming Interface (API) as well as an abstraction for platform independent (e.g. Java) applications called mobilets. This framework allows server application and client application interaction on a class of devices in a vendor neutral manner.

### Layered End-to-End Protocol Architecture

This is a peer-to-peer set of layers defined to optimize definition of services by abstracting out the effects of rapid changes in technology. In one or more embodiments, each layer of the architecture provides a certain set of services to the upper layer and uses certain services from the layer below.

In one embodiment, the expense of online connectivity for the wireless user forces the focus on offline content accessing with the exception of time-sensitive data (e.g. stock quotes). Thus, the mobile device acts as a cache or reservoir of information that may periodically synchronize with a server to update its cache. Optionally, a push service may send important events to the device. This means that continuous connectivity is not necessary unless time sensitive and real-time information is needed.

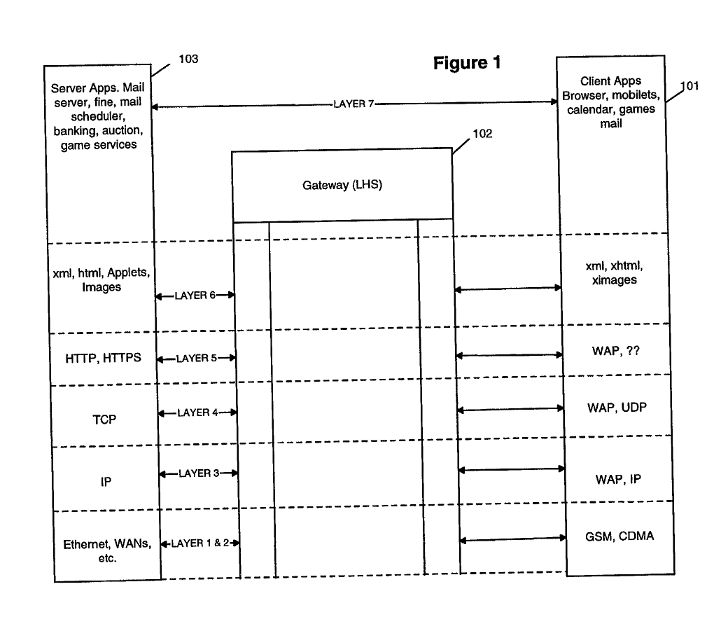

FIG. 1 shows a diagram of the end-to-end protocol view for the wireless clients.

There are seven protocol layers and three service tiers in the model. The model is based on the OSI 7 layer architecture specified in “Computer Networks” by Tanenbaum. The three-tier architecture comprises the client tier, the gateway tier, and the server tier. The client tier, block 101, comprises a KVM (K Virtual Machine) or equivalent virtual machine capable of scheduling device independent applications. The KVM is the small device equivalent of the Java Virtual Machine (JVM). Like JVM, the KVM coexists with the native operating system and other software on the client device. Other Java packages are used to provide an API for Web like (e.g. WAP, XHTML) functionality, sandbox security, a framework for running Java applications, and other services.

The Wireless Gateway tier 102 is responsible for providing services that lighten the load on the client by doing as much preprocessing as possible and for any protocol translation between the server and the client device. For example, the gateway performs content transformation to WML (Wireless Markup Language) or XHTML, converts from HTTP (Hyper Text Transport Protocol) to WAP, does Byte-code verification, authenticates Java applications, provides push services, and other services.

The Server tier 103 comprises a large group of services that may be available on enterprise servers. Some of the services are provider dependent and run on client devices. Examples of services are banking applications, brokerage services, etc. Servers may also use push services to push client applications into the client device making the client applications portals into the services provided by the server.

Each layer of the architecture provides a certain service and the subdivision is arranged to provide certain advantages. For example, different vendors may choose to implement or support different standards for communication with their clients. Client devices may have different capabilities or may use different implementation to provide same functionality. It also allows software to be easily portable between client devices.

Layers 1 and 2 are the physical and data link layers. The connections on the server side (i.e. server to gateway communication) may be through an Ethernet, Wide Area Network (WAN), the Internet, or other similar communication network. The gateway to client side communication may be through any of the available wireless communication protocols such as GSM, CDMA, and TDMA.

Layer 3 is a network layer with IP (Internet Protocol) communication between the server and the gateway. The gateway to client side may use IP or WAP protocol for communication. Layer 4 is the transport layer probably using TCP (Transmission Control Protocol) on the server to gateway side and WAP, UDP (User Datagram Protocol), or TCP on the gateway to client side. The WAP may be more efficient because it allows data for compression, however, most current Web transport services use TCP.

Layer 5 is the session layer involving HTTP, HTTPS (i.e., secure HTTP), and other forms of communication between services on the server to gateway side. WAP may be the most efficient system on the gateway to client side because it has an efficient mechanism for Gets and Sets functions. Layer 6 is the presentation for markup and may use HTML, or XML (Extensible Markup Language) for server to gateway communication. The gateway to client side may use WML (Wireless Markup Language), or XHTML for communication. WML is more than a markup language because it has telephony extensions.

The final layer, 7, is the applications layer. This layer includes preparation of graphical data for presentation, action oriented metaphors, directory services, mail services, and etc. Graphical data between the server and the gateway is presented in a format such as GIF (Graphical Interchange Format) or JPEG. This data is converted in the gateway tier to a format such as WAP compressed 4-bit graphics (i.e. bitmaps) for communication to the client device.

Action oriented metaphors, such as JavaScripts and applets, from the server side are converted by the gateway to WMLScript and mobilets, respectively, before transmission to the client device. For directory services, the gateway acts as proxy to the client tier. Mail services may be sent via standard text paging systems to the client from the gateway.

In this three-tier architecture, the gateway is below the application layer and acts as a general purpose protocol transformation engine. Therefore, the gateway has very little to do with how server applications and client applications interact in a peer-to-peer fashion. The gateway can be used to do bytecode verification and to target client devices belonging to a particular category. The wireless gateway handles communications between server and client in order to accommodate bandwidth restrictions, space restrictions, and security concerns that are specific to wireless devices, and also Internet constraints by providing some kind of barrier and transformation between client and server. For example, the gateway may take Web pages from a server and strip out of the contents some unnecessary information and make it available to wireless phones without any problem.

Authentication, security, and encryption issues on the server to gateway side may be handled using digital certificates, Secure Sockets, Digital Hashes (e.g. MD5), RSA and DES encryption of various strengths.

### Client Tier Internal Architecture

The protocol mapping and end-to-end architecture discussed above highlights the difficulty in developing applications based on any particular set of protocols even for the same class of devices. It is harder still for general purpose wireless service providers to support client applications on the vast array of wireless devices even with the help of transformation gateway support since applications do not have access to the same set of local services. The present invention defines local services available on the client device that would allow applications to run provider-neutral and in platform independent manner. A layered architecture is defined that encapsulates protocol and system specific implementation features in abstractions. For example, the client does not have to worry about the markup language (WML or XHTML) or whether or not the protocol engine is implemented in native or Java.

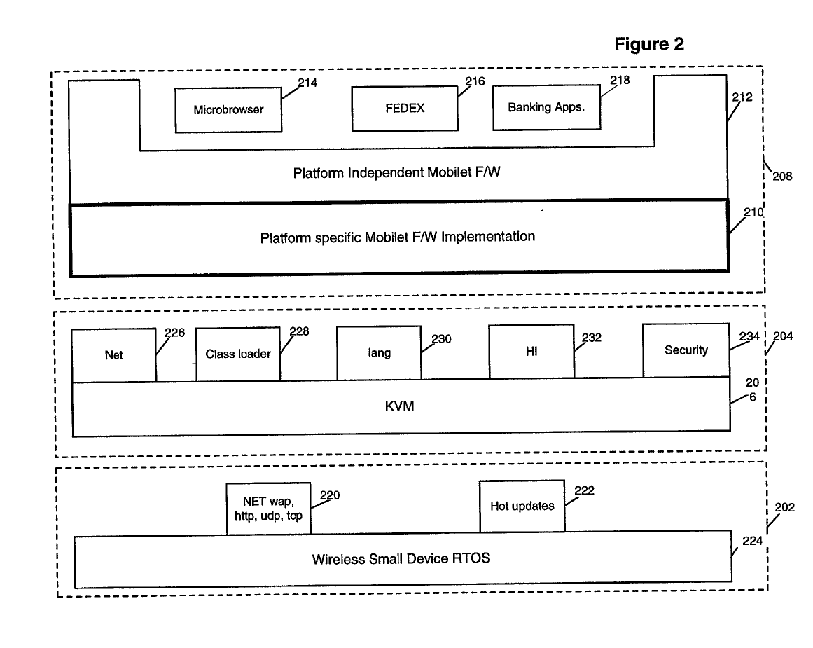

FIG. 2 is an illustration of the layered structure of the client tier. The RTOS (Real Time Operating System) layer 202 comprises the wireless small device operating system 224 with its linking and networking APIs block 220. The hot updates object 222 allows updates and installation of new pieces of software on the client device RTOS layer without affecting other layers in the architecture and without the client device requesting for the update. RTOS 224 is generally native code (i.e. device dependent), but may be written in object-oriented language like Java. In one or more embodiments, layers 202, 204, and block 210 may be written in native code.

On top of the RTOS layer 202 is the virtual machine (VM) layer 204. VM layer 204 comprises the K Virtual Machine 206 and system classes 226 through 234. System classes 206 through 226 are integral part of the K Virtual Machine. As discussed earlier, the K Virtual Machine is a small device version of the Java Virtual Machine (JVM). The KVM allows multi-threading in order to make inter-mobilet interaction easy and predictable. Although KVM and JVM are used in this specification, it would be obvious to those of ordinary skills that any virtual machine that performs similar functions can be used instead to provide similar functionality.

The final layer is the application layer 208. This layer contains the platform specific mobilet framework object class 210, the platform independent mobilet framework object class 212, and application object classes 214 through 218. This arrangement allows application objects 214 through 218 to be platform and vendor neutral.

Application objects 214 through 218 are the mobilets. In one or more embodiments, the present invention is used to track shipping packages. For example, assuming FedEx has a shipment for a client, mobilet 21 6 could be subscribed to during shipping, which would automatically provision (i.e. push out to) the client's wireless device. Another example is if a client is about to receive a package from FedEx, the recipient's wireless phone will automatically be provisioned with FedEx mobilet 216 if the sender had provided a phone number during shipping. When the package arrives at the recipient's door, they will either get a phone call, or mobilet 216 runs and alerts the client of the arrival.

Basically, service providers may have mobilets ready to run on service recipient's wireless devices. The present invention allows service providers like FedEx to alert clients of important events if the clients have wireless devices that can be provisioned with mobilets. Also, a client sending a package to somebody else may track the package with their cell phone if the cell phone has a tracking mobilet (e.g. FedEx mobilet 216). Similarly, a client using their cell phone can connect to a stock ticker provider to get the current value of stocks. The service provider or ticker provider can push the mobilet required to view the ticker to the wireless device. Thus, the present invention allows wireless device users to subscribe to services on the fly.

The platform handles all communications between the wireless device and the service provider using mobilets that implement user interface functions. Functionally, mobilets would be capable of determining how the platform works, what kind of user interfaces are supported, and the best way to display information. For example, if the device does not have a browser then mobilets handle the browser function.

Available services include subscription, publishing, sinking, etc. A service provider may publish available services and clients can subscribe to available services on the fly. Sinking allows clients that have desktop machines from which they can access e-mail, calendar, and other functions to sink-up their cell phones or wireless devices with their desktop to allow access to those functions from the wireless device.

A service provider may broadcast availability of certain services. Client's that are interested may pick and choose those services they would like to subscribe to, for example, stock ticker for tracking investments and FedEx mobilet for tracking packages. If a client is not subscribing to FedEx but the client would like to track an incoming package or outgoing package then the client's service provider can push that mobilet into the client's wireless device. Another example is that a client may be interested in subscribing to some services available on the Internet.

### Mobilet Framework

A mobilet, like an applet, is an application written to the mobilet framework specifications. It resides on top of a thin runtime container (Mobilet framework). Mobilets have a default behavior unless the mobilet developer overrides the APIs. Although mobilets can communicate with each other through the framework, the state of each mobilet is managed by a mobilet manager. Thus, the mobilet manager manages all the mobilets in the framework. The mobilet manager is responsible for starting, stopping, initializing, suspending, etc. for all mobilets. For example, a mobilet cannot requisition the display screen of the wireless device without permission from the mobilet manager.

Most wireless devices are usually very limited in visual display capability therefore only one application may operate in the foreground. This invention provides a desktop type metaphor that is a desktop kind of feel for applications on the wireless device. This means that the user should be able to switch between applications just like on the desktop. But in general, only one application will be active in the foreground at a time. The remaining applications may be in the background. Other applications may be active in the background so long as they are not consuming much resource. For example, one thread could be waiting on a circuit and when it becomes active, it might try to take the foreground by requesting for access from the mobilet manager.

Each mobilet has an identification (ID) that uniquely refers to it. The mobilet ID may contain references to its name, and other information (e.g. platform dependent messages). The contents of the mobilet ID are generally not visible to the mobilet except for certain method calls. The mobilet manager handles each mobilet without a pointer that way one mobilet cannot interfere in the operations of another mobilet.

The mobilet manager creates a registry of all mobilets in the framework. When a mobilet is started and is initialized, its ID is stored in the mobilet registry. The mobilet manager may then pass an object (e.g. a cookie) to the mobilet so that the mobilet may discover the environment around it. Most of the environment information is stored in the mobilet manager, but a cookie is a safe interaction because it is in standard API, i.e., standard object calls.

The mobilet manager is responsible for giving mobilets life by giving them a mobilet ID and stuffing them in the mobilet registry. The manager is responsible for initializing, stopping, stocking, putting the mobilets in the background. No mobilet function happens directly without permission from the mobilet manager. So if one mobilet wants access to the screen, it must request it through the mobilet manager. If it's okay (e.g. a higher priority task or the current active task is preemptable), then the manager will shut down the active mobilet by placing it in the background before bringing the requesting mobilet to the foreground. Examples of higher priority tasks include event messenger and instant messenger services. These services may notify the user and request confirmation whether the user wants to view the messages instantly. However, no mobilet may directly request other mobilet to relinquish access. Access must always be obtained through the mobilet manager, so there is an access control to minimize the possibilities for destructive interaction. For example, in order to notify the user and request confirmation whether or not to view a message, the service must first request access for the screen from the mobilet manager.

The mobilet manager does validation of the mobilet ID with collaboration from the mobilet registry. References to a mobilet are via its ID. The registry is a table of what kind of services are available, i.e., what type of mobilets are available, there capabilities, and what kind of information they contain. For example, the e-mail may want to use a calendar function so it would inquire from the mobilet registry for available services. If there is a calendar function, it may then request, from the mobilet manager, that the calendar function be put in the foreground.

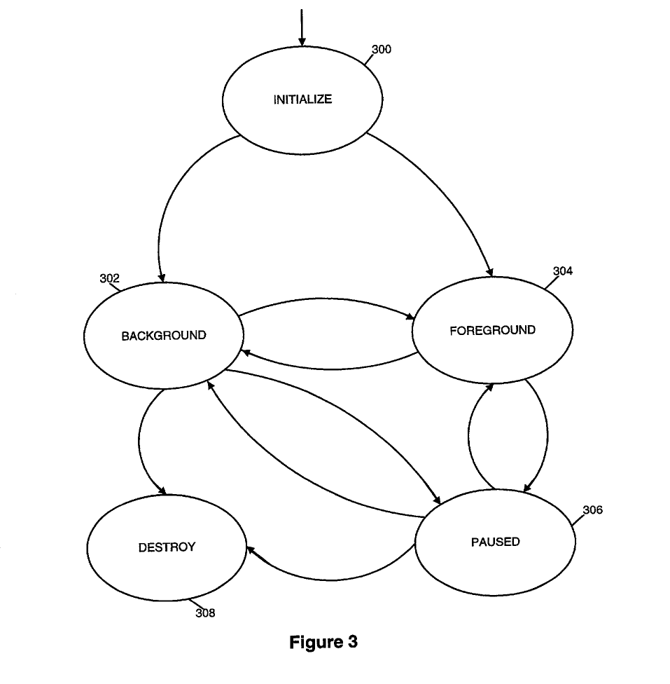

The mobilet manager handles launching of applications (i.e. mobilets), inter-mobilet communication, lifecycle of mobilets, registration of mobilets, the state of each mobilet, user interface (i.e. interaction), etc. FIG. 3 is a state diagram of the life of a mobilet. At state 300, the mobilet is initialized; the mobilet manager passes a context (e.g. a cookie) to allow the mobilet to determine its environment. The mobilet manager then creates the mobilet by giving it an ID and publishing it in the registry. After registration is complete, the mobilet may request move to the foreground, if granted, the mobilet is put in state 304, otherwise it is in state 302. At state 304, the mobilet has access to resources like the display, and other user interface components.

If access is not granted to proceed to foreground 304, the mobilet is put in the background state 302. A mobilet can only be destroyed from either the background state 302 or from the paused state 306. The mobilet manager may move the mobilet between the background state 302, foreground state 304, and the paused state 306, depending on priorities and usage requirements. In this fashion, the mobilet manager manages the state of the mobilet once it has been initialized and is in the framework.

Because the framework makes the wireless device act like a cache of services, it allows for download of proxy stubs that convert the wireless device into a service provider. Thus, in the service provider configuration, the wireless device may be used to provide services to other wireless devices, for example. The framework also provides persistent storage for client applications and sandbox security to prevent collision and inadvertent destruction of services.

In one or more embodiments of the present invention, sample Java™ language source code implementing the framework and its embedded services are provided in Appendix A.

### Embodiment of a Processing Environment

An embodiment of the invention is directed, though not limited, to distributed applications, such as those in which a server application serves one or more wireless client applications. Such systems may be implemented using object-oriented programming environments that produce executable software objects. To facilitate object compatibility between the client and server, the software objects may be implemented in a platform independent manner, or the client and server systems may share common or compatible operating platforms. The clients and server may execute within separate machine or virtual machine runtime environments, within a single runtime environment, or a combination of the foregoing arrangements. The following description refers to an embodiment of a virtual machine-based runtime environment, though it will be obvious that the invention is not limited to such.

Applications typically comprise one or more object classes. Classes written in high-level programming languages, such as the Java™ programming language, may be compiled into machine independent bytecode class files. Alternatively, classes may be compiled into machine dependent, executable program code for direct execution by a given hardware platform. In the machine independent case, each class file contains code and data in a platform-independent format called the class file format.

The computer system acting as the execution vehicle contains a program called a virtual machine, which is responsible for executing the code in each class file. (A hardware system may also be used that directly executes bytecode of class files.)

In a virtual machine environment, the classes of an application are loaded on demand from the network (stored on a server), or from a local file system, when first referenced during the application's execution. The virtual machine locates and loads each class file, parses the class file format, allocates memory for the class's various components, and links the class with other already loaded classes. This process makes the code in the class readily executable by the virtual machine.

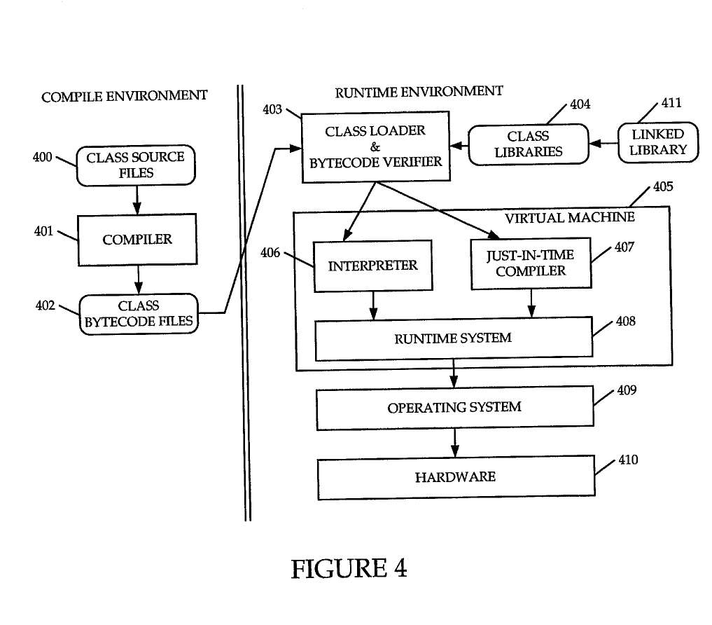

FIG. 4 illustrates the compile and runtime environments for an example processing system. In the compile environment, a software developer creates source files 400, which contain the programmer readable class definitions written in the source programming language, including data structures, method implementations and references to other classes. Source files 400 are provided to pre-compiler 401, which compiles source files 400 into “.class” files 402 that contain bytecodes executable by a virtual machine. Bytecode class files 402 are stored (e.g., in temporary or permanent storage) on a server, and are available for download over a network. Alternatively, bytecode class files 402 may be stored locally in a directory on the client platform.

The runtime environment contains a virtual machine (VM) 405 which is able to execute bytecode class files and execute native operating system (“O/S”) calls to operating system 409 when necessary during execution. Virtual machine 405 provides a level of abstraction between the machine independence of the bytecode classes and the machine-dependent instruction set of the underlying computer hardware 410, as well as the platform-dependent calls of operating system 409.

Class loader and bytecode verifier (“class loader”) 403 is responsible for loading bytecode class files 402 and supporting class libraries 404 into virtual machine 405 as needed. Class loader 403 also verifies the bytecodes of each class file to maintain proper execution and enforcement of security rules. Within the context of runtime system 408, either an interpreter 406 executes the bytecodes directly, or a “just-in-time” (JIT) compiler 407 transforms the bytecodes into machine code, so that they can be executed by the processor (or processors) in hardware 410.

The runtime system 408 of virtual machine 405 supports a general stack architecture. The manner in which this general stack architecture is supported by the underlying hardware 410 is determined by the particular virtual machine implementation, and reflected in the way the bytecodes are interpreted or JIT-compiled. Other elements of the runtime system include thread management (e.g., scheduling) and garbage collection mechanisms.

### Embodiment of Computer Execution Environment (Hardware)

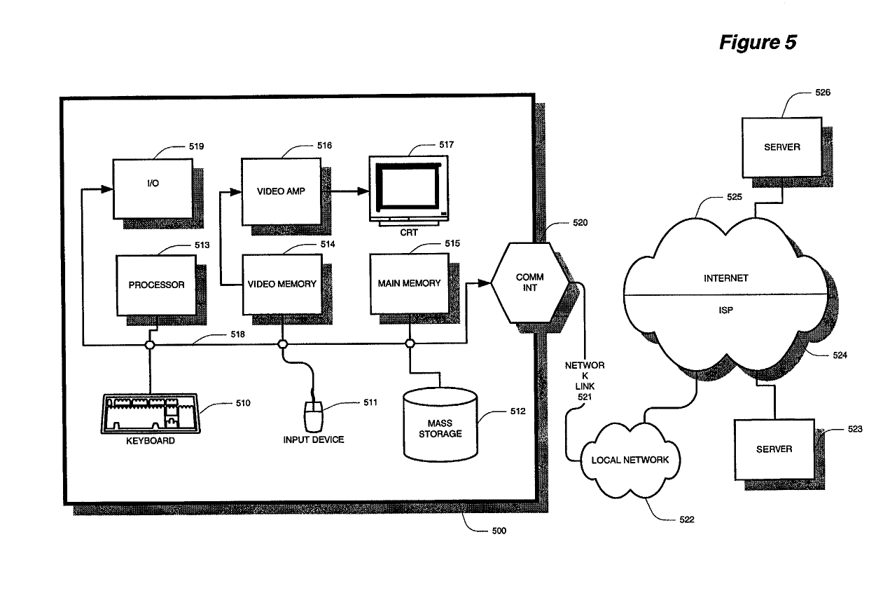

An embodiment of the invention can be implemented as computer software in the form of computer readable code executed on any computer processing platform, or in the form of software (e.g., bytecode class files) that is executable within a runtime environment running on such a processing platform. An embodiment of the invention may be implemented in any type of computer system or programming or processing environment, including embedded devices (e.g., web phones, set-top boxes, etc.) and “thin” client processing environments (e.g., network computers (NC's), etc.). An example of a general computer system is illustrated in FIG. 5. The computer system described below is for purposes of example only.

In FIG. 5, keyboard 510 and mouse 511 are coupled to a system bus 518. The keyboard and mouse are for introducing user input to the computer system and communicating that user input to processor 513. Other suitable input devices may be used in addition to, or in place of, the mouse 511 and keyboard 510. I/O (input/output) unit 519 coupled to system bus 518 represents such I/O elements as a printer, A/V (audio/video) I/O, etc.

Computer 500 includes a video memory 514, main memory 515 and mass storage 512, all coupled to system bus 518 along with keyboard 510, mouse 511 and processor 513. The mass storage 512 may include both fixed and removable media, such as magnetic, optical or magnetic optical storage systems or any other available mass storage technology. Bus 518 may contain, for example, address lines for addressing video memory 514 or main memory 515. The system bus 518 also includes, for example, a data bus for transferring data between and among the components, such as processor 513, main memory 515, video memory 514 and mass storage 512. Alternatively, multiplexed data/address lines may be used instead of separate data and address lines.

In one embodiment of the invention, the processor 513 is a SPARC™ microprocessor from Sun Microsystems, Inc. or a microprocessor manufactured by Intel, such as the 80X86, or Pentium processor, or a microprocessor manufactured by Motorola, such as the 680X0 processor. However, any other suitable microprocessor or microcomputer may be utilized. Main memory 515 is comprised of dynamic random access memory (DRAM). Video memory 514 is a dual-video random access memory. One port of the video memory 514 is coupled to video amplifier 516. The video amplifier 516 is used to drive the cathode ray tube (CRT) raster monitor 517. Video amplifier 516 is well known in the art and may be implemented by any suitable apparatus. This circuitry converts pixel data stored in video memory 514 to a raster signal suitable for use by monitor 517. Monitor 517 is a type of monitor suitable for displaying graphic images. Alternatively, the video memory could be used to drive a flat panel or liquid crystal display (LCD), or any other suitable data presentation device.

Computer 500 may also include a communication interface 520 coupled to bus 518. Communication interface 520 provides a two-way data communication coupling via a network link 521 to a local network 522. For example, if communication interface 520 is an integrated services digital network (ISDN) card or a modem, communication interface 520 provides a data communication connection to the corresponding type of telephone line, which comprises part of network link 521. If communication interface 520 is a local area network (LAN) card, communication interface 520 provides a data communication connection via network link 521 to a compatible LAN. Communication interface 520 could also be a cable modem or wireless interface. In any such implementation, communication interface 520 sends and receives electrical, electromagnetic or optical signals which carry digital data streams representing various types of information.

Network link 521 typically provides data communication through one or more networks to other data devices. For example, network link 521 may provide a connection through local network 522 to local server computer 523 or to data equipment operated by an Internet Service Provider (ISP) 524. ISP 524 in turn provides data communication services through the world wide packet data communication network now commonly referred to as the “Internet” 525. Local network 522 and Internet 525 both use electrical, electromagnetic or optical signals which carry digital data streams. The signals through the various networks and the signals on network link 521 and through communication interface 520, which carry the digital data to and from computer 500, are exemplary forms of carrier waves transporting the information.

Computer 500 can send messages and receive data, including program code, through the network(s), network link 521, and communication interface 520. In the Internet example, remote server computer 526 might transmit a requested code for an application program through Internet 525, ISP 524, local network 522 and communication interface 520.

The received code may be executed by processor 51 3 as it is received, and/or stored in mass storage 512, or other non-volatile storage for later execution. In this manner, computer 500 may obtain application code in the form of a carrier wave. Application code may be embodied in any form of computer program product. A computer program product comprises a medium configured to store or transport computer readable code or data, or in which computer readable code or data may be embedded. Some examples of computer program products are CD-ROM disks, ROM cards, floppy disks, magnetic tapes, computer hard drives, servers on a network, and carrier waves.

Thus, an application framework for mobile devices have been described in conjunction with one or more specific embodiments. The invention is defined by the claims and their full scope of equivalents.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. An application framework for mobile devices comprising:
a multi-tier architecture comprising a first tier capable of processing device-independent applications, a third tier providing a plurality of services to said first tier, a second tier for preprocessing communications between said first tier and said third tier thereby reducing processing requirements on said first tier;
a plurality of peer-to-peer communication layers between said third tier and said first tier through said second tier, said second tier providing protocol translation between said third tier and said first tier.

2. The application framework of claim 1, wherein said plurality of peer-to-peer layers comprises:
at least one physical data link layer
a network layer;
a transport layer;
a session layer;
a presentation layer; and
an applications layer.

3. The application framework of claim 2, wherein said at least one physical data link layer comprises landline communication between said third tier and said second tier, and wireless communication between said second tier and said first tier.

4. The application framework of claim 2, wherein said network layer uses Internet Protocol communication between said third tier and said second tier, and wireless applications protocol between said second tier and said first tier.

5. The application framework of claim 2, wherein said transport layer uses transport control protocol between said third tier and said second tier, and wireless applications protocol between said second tier and said first tier.

6. The application framework of claim 2, wherein said session layer uses hypertext transport protocol between said third tier and said second tier and amongst services in said third tier, and wireless applications protocol between said second tier and said first tier.

7. The application framework of claim 2, wherein said presentation layer uses a markup language between said third tier and said second tier, and a wireless markup language between said second tier and said first tier.

8. The application framework of claim 2, wherein said application layer prepares graphical data for presentation, said graphical data being available in any suitable graphical format and communicated from said third tier to said second tier, said second tier converting said graphical data to a wireless graphics format for transmission to said first tier.

9. The application framework of claim 1, wherein said first tier is a wireless device.

10. The application framework of claim 9, wherein said wireless device is a cellular phone.

11. The application framework of claim 9, wherein said wireless device is a palm device.

12. The application framework of claim 9, wherein said wireless device includes a software architecture comprising:
a real-time operating system layer;
a virtual machine layer having at least one system class; and
an application layer.

13. The application framework of claim 12, wherein said real-time operating system layer comprises: a wireless small device operating system; a plurality of linking and networking application programming interfaces; and an object for updating and installing software in said wireless device.

14. The application framework of claim 12, wherein said application layer comprises:
a platform specific framework object class;
a platform independent framework object class; and
at least one application object class.

15. The application framework of claim 14, wherein said at least one application object class may operate in any of a plurality of states, wherein said plurality of states comprises an initialization state, a background state, a foreground state, a destroy state, and a paused state.

16. The application framework of claim 15, further comprising a manager object for managing each of said at least one application object class in said plurality of states.

17. An application framework for mobile devices comprising:
a multi-tier architecture comprising a client tier having a virtual machine capable of processing device-independent applications, a server tier providing a plurality of services to said client tier in the form of said device-independent applications, a gateway tier for preprocessing communications between said client tier and said server tier thereby reducing processing requirements on said client tier;
a plurality of peer-to-peer communication layers between said server tier and said client tier through said gateway tier, said gateway tier providing protocol translation between said server tier and said client tier;
a manager object in said client tier for managing said device-independent applications, each of said device-independent applications having a plurality of states, wherein said plurality of states comprises an initialization state, a background state, a foreground state, a destroy state, and a paused state.

18. A multi-tier system for providing vendor-neutral communication to mobile devices comprising:
a client device having a virtual machine capable of processing device-independent applications, a plurality of servers providing a plurality of services to said client device in the form of said device-independent applications, a gateway for preprocessing communications between said client device and said plurality of servers thereby reducing processing requirements on said client device;
a plurality of peer-to-peer communication layers between said plurality of servers and said client device through said gateway, said gateway providing protocol translation between said plurality of servers and said client device;
a manager object in said client device for managing said device-independent applications, each of said device-independent applications having a plurality of states, wherein said plurality of states comprises an initialization state, a background state, a foreground state, a destroy state, and a paused state.
